(19) United States
(12) Patent Application Publication
(10) Pub. No.: US 2025/0252306 A1
(43) Pub. Date: Aug. 7, 2025

(54) SYSTEM AND METHOD FOR UNCERTAINTY-AWARE TRAVERSABILITY ESTIMATION WITH OPTIMUM-FIDELITY SCAN DATA

(71) Applicant: Field AI, Inc., Mission Viejo, CA (US)

(72) Inventors: Samuel Triest, Mission Viejo, CA (US); David Fan, Mission Viejo, CA (US); Ali Agha Akbar Mohammadhi, Mission Viejo, CA (US)

(21) Appl. No.: 19/045,594

(22) Filed: Feb. 5, 2025

Related U.S. Application Data
(60) Provisional application No. 63/549,614, filed on Feb. 5, 2024.

(51) Int. Cl. G06N 3/08

(52) U.S. Cl. CPC G06N 3/08

(57) ABSTRACT

A ML-based system and method for determining traversability with uncertainty object estimation for one or more robot devices to navigate through one or more terrains, is disclosed. The ML-based method comprises: (a) obtaining optimum-fidelity scan data in a form of point cloud from scanner devices; (b) generating an elevation map of the environments by applying an elevation mapping model and free-space detection model on the point cloud; (c) generating a dense point cloud with ground-truth map features from the elevation map of the environments; (d) generating a synthetic point cloud based on the dense point cloud of the environments; (e) predicting traversability features from the synthetic point cloud associated with the environments using a ML model; and (f) determining the traversability with the uncertainty object estimation, which adapts the robot devices to navigate on the terrains, based on the traversability features predicted from the ML model.

### CROSS REFERENCE TO RELATED APPLICATION(S)

This application claims the priority to and incorporates by reference the entire disclosure of U.S. provisional patent application bearing No. 63/549,614 filed on Feb. 5, 2024 with the United States Patent and Trademark Office.

### TECHNICAL FIELD

Embodiments of the present disclosure relate to machine learning (ML) based robotic systems, and more particularly relate to a ML-based system and method for uncertainty-aware traversability determination/estimation with optimum-fidelity scan data for one or more robot devices to navigate through diverse and challenging terrains while considering uncertainties in one or more environments.

### BACKGROUND

The deployment of one or more robotic devices in rough-terrain applications, such as construction and disaster response, has become increasingly prevalent. Legged robotic devices, in particular, hold promise for executing tasks that are both time-consuming and dangerous. However, these rough-terrain applications present challenges for mobility, including clutter, dangerous terrain, occlusions, and dynamic changes over time. Traversability estimation is a critical aspect of the one or more robotic devices navigation, determining feasibility of traversing different terrains and environments. Commonly, the traversability estimation involves analysis of environmental features, such as slope, roughness, and obstacles, to plan safe and efficient paths.

Conventional approaches to the traversability estimation often rely on accurate perception to reconstruct a local environment. Existing methods often rely on high-precision scanning technologies, such as laser scanners, to gather detailed environmental data. However, the conventional approaches face limitations in handling uncertainties inherent in real-world scenarios, including sensor noise, occlusions, and dynamic changes in the local environment. These limitations lead to inaccuracies in the traversability estimation and pose challenges for robust autonomous navigation.

Learning-based approaches, leveraging deep neural networks, have emerged as a promising solution. These deep neural networks generate complex forecasts capturing abstract environmental priors, offering a potential breakthrough in addressing the limitations of the conventional approaches. However, generating precise ground-truth labels in sufficient quantities for training these deep neural networks presents a significant challenge.

Conventionally, the traversability estimation has explored the use of aggregated future sensing data to address a label generation challenge. Simulation is considered, but simulation often falls short in representing the complexity of real-world environments. Additionally, the uncertainty is a critical component in the traversability estimation, as certain environmental ambiguities are not resolved solely through onboard sensing.

In the existing technology, a system for generating neural network point clouds is described. This system comprises one or more processors and a memory storing a generative adversarial network (GAN). The processors are designed to receive a low-resolution point cloud consisting of a set of three-dimensional (3D) data points representing an object. The GAN's generator generates a first set of data points based on characteristics of the low-resolution point cloud, interpolating them into the existing low-resolution point cloud to create a super-resolved point cloud that offers higher resolution. The processors are additionally configured to analyze the super-resolved point cloud for detecting attributes such as the object's identity or damage. However, the system lacks operating a low-resolution sensor onboard, training a neural network model on very high-resolution data to predict information for safely and successfully navigating the one or more robotic devices in the real-world environments.

There are various technical problems with the traversability estimation in the prior art. In the existing technology, several technical challenges and limitations persist in the domain of the traversability estimation. These challenges significantly impact the performance and reliability of autonomous systems operating in complex and dynamic environments. The traversability estimation often relies on odometry data to track the position and movement of the one or more robotic devices. However, the accumulation of odometry drift over time results in misalignment between a perceived and actual location of the one or more robotic devices. Learning-based methods, including the neural networks, have shown promise in the traversability estimation. However, the generation of high-quality ground-truth labels for training these neural networks is a challenging task. While simulations are employed to generate labeled data, they often fall short in capturing intricacies of the real-world environments. Simulated environments may lack the diversity, complexity, and uncertainties present in actual scenarios, resulting in a simulation-to-real gap that affects the system performance when deployed in the real world.

Therefore, there is a need for an improved machine learning based system and method for determining traversability with uncertainty object estimation for one or more robot devices to navigate through one or more terrains, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) method for determining traversability with uncertainty object estimation for one or more robot devices to navigate through one or more terrains is disclosed. The ML-based method comprises obtaining, by one or more hardware processors, optimum-fidelity scan data in a form of point cloud from one or more scanner devices. The optimum-fidelity scan data generated by the one or more scanner devices comprise at least one of: one or more three-dimensional point clouds, information associated with optimum-resolution surfaces, depth and distance measurements, color and intensity attributes, spatial coordinates, associated with one or more environments.

The ML-based method further comprises generating, by the one or more hardware processors, an elevation map of the one or more environments by applying at least one of: an elevation mapping model and free-space detection model on the point cloud. The ML-based method further comprises generating, by the one or more hardware processors, a dense point cloud with one or more ground-truth map features from the elevation map of the one or more environments. The ML-based method further comprises generating, by the one or more hardware processors, a synthetic point cloud based on the dense point cloud of the one or more environments.

The ML-based method further comprises predicting, by the one or more hardware processors, one or more traversability features from the synthetic point cloud associated with the one or more environments using a machine learning (ML) model. The ML-based method further comprises determining, by the one or more hardware processors, the traversability with the uncertainty object estimation, which adapts the one or more robot devices to navigate on the one or more terrains, based on the one or more traversability features predicted from the ML model.

In an embodiment, the ML-based method further comprises extracting, by the one or more hardware processors, the one or more traversability features comprising at least one of: step, slope, and roughness, of the one or more terrains, from one or more neighborhoods of one or more elevation cells, based on an analysis of the elevation map of the one or more environments.

In another embodiment, the ML-based method further comprises training, by the one or more hardware processors, the ML model, by: (a) obtaining, by the one or more hardware processors, one or more training datasets from the generated dense point cloud with the one or more ground-truth map features; (b) training, by the one or more hardware processors, the ML model with the one or more training datasets obtained from the generated dense point cloud with the one or more ground-truth map features; and (c) predicting, by the one or more hardware processors, the one or more traversability features using the trained ML model.

In yet another embodiment, generating the synthetic point cloud based on the dense point cloud of the one or more environments, comprises: (a) collecting, by the one or more hardware processors, one or more poses indicating one or more virtual viewpoints, in one or more free spaces in the one or more environments; (b) projecting, by the one or more hardware processors, the generated dense point cloud into one or more frames defined by the collected one or more poses; (c) cropping, by the one or more hardware processors, the one or more ground-truth map features upon a transformation process on the one or more ground-truth map features, based on the collected one or more poses; and (d) applying, by the one or more hardware processors, noising data to the synthetic point cloud associated with the one or more training datasets to make the synthetic point cloud having outputs similar to outputs of one or more low-resolution sensors associated with the one or more robot devices.

In yet another embodiment, predicting the one or more traversability features from the synthetic point cloud associated with the one or more environments using the machine learning (ML) model, comprises: (a) defining, by the one or more hardware processors, one or more metric regions around an ego-pose comprising at least one of: a resolution, width and height, in the synthetic point cloud; (b) passing, by the one or more hardware processors, one or more points in the one or more metric regions through a point pillars network comprising at least one of: a point net and a cell-wise max-pooling; and (c) generating, by the one or more hardware processors, a cell-wise and factorized gaussian distribution for the one or more traversability features based on the point pillars network with the one or more points in the one or more metric regions, using the ML model.

In yet another embodiment, the ML-based method further comprises at least one of: analyzing, by the one or more hardware processors, the traversability as probability that the predicted one or more traversability features are below to critical threshold values; and analyzing, by the one or more hardware processors, the traversability with the uncertainty object estimation when the predicted one or more traversability features are exceeded to the critical threshold values.

In yet another embodiment, the ML-based method further comprises re-training, by the one or more hardware processors, the ML model for the one or more robot devices based on at least one of: static traversability estimation at an execution time, changing of cost function, and one or more user requirements.

In an aspect, a machine-learning based (ML-based) system for determining traversability with uncertainty object estimation for one or more robot devices to navigate through one or more terrains, is disclosed. The ML-based system comprises one or more hardware processors and a memory coupled to the one or more hardware processors. The memory comprises a plurality of subsystems in form of programmable instructions executable by the one or more hardware processors.

The plurality of subsystems comprises a data obtaining subsystem configured to obtain optimum-fidelity scan data in a form of point cloud from one or more scanner devices. The optimum-fidelity scan data generated by the one or more scanner devices comprise at least one of: one or more three-dimensional point clouds, information associated with optimum-resolution surfaces, depth and distance measurements, color and intensity attributes, spatial coordinates, associated with one or more environments.

The plurality of subsystems further comprises an elevation map generating subsystem configured to generate an elevation map of the one or more environments by applying at least one of: an elevation mapping model and free-space detection model on the point cloud. The plurality of subsystems further comprises a point cloud generating subsystem configured to: (a) generate a dense point cloud with one or more ground-truth map features from the elevation map of the one or more environments; and (b) generate a synthetic point cloud based on the dense point cloud of the one or more environments.

The plurality of subsystems further comprises a traversability predicting subsystem configured to: (a) predict one or more traversability features from the synthetic point cloud associated with the one or more environments using a machine learning (ML) model; and (b) determine the traversability with the uncertainty object estimation, which adapts the one or more robot devices to navigate on the one or more terrains, based on the one or more traversability features predicted from the ML model.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture of a machine learning based (ML-based) system for uncertainty-aware traversability estimation with optimum-fidelity scan data, in accordance with an embodiment of the present disclosure;

FIG. 2 illustrates an exemplary block diagram representation of the ML-based system, as shown in FIG. 1, for the uncertainty-aware traversability estimation with the optimum-fidelity scan data, in accordance with an embodiment of the present disclosure;

FIG. 3 illustrates an exemplary overview of the ML-based system, in accordance with an embodiment of the present disclosure;

FIG. 4 illustrates an exemplary optimum-fidelity scan data of loose wires, in accordance with an embodiment of the present disclosure;

FIG. 5 illustrates an exemplary visualization of a datapoint associated with the ML-based system, in accordance with an embodiment of the present disclosure;

FIG. 6 illustrates an exemplary visualization of a traversability forecast/prediction with a ML model (e.g., UNRealNet) output on a sample in sixth environment (env6), in accordance with an embodiment of the present disclosure;

FIG. 7 illustrates an exemplary case study for elevation forecast, in accordance with an embodiment of the present disclosure;

FIG. 8 illustrates exemplary additional qualitative results from a seventh environment, in accordance with an embodiment of the present disclosure; and

FIG. 9 illustrates a flow chart illustrating a machine learning based (ML-based) method for the uncertainty-aware traversability estimation with the optimum-fidelity scan data, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

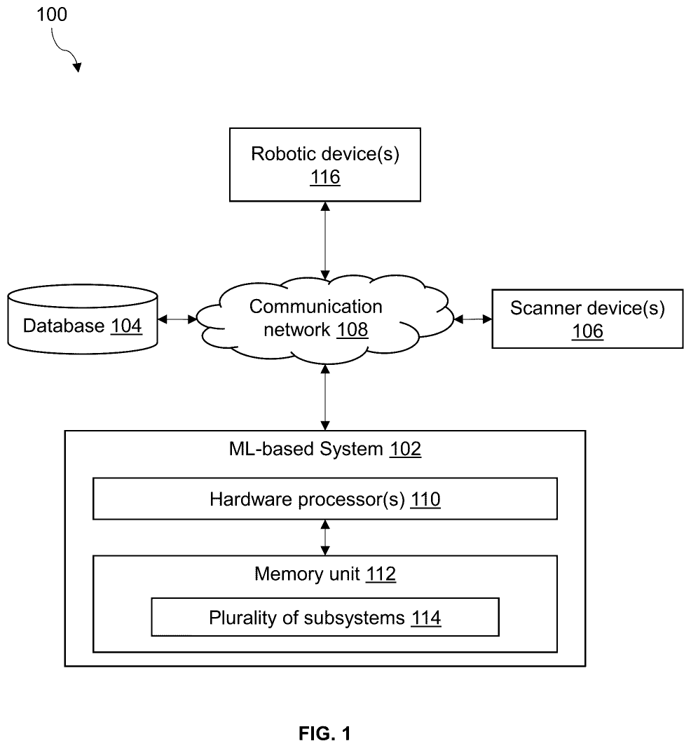

Referring now to the drawings, and more particularly to FIG. 1 through FIG. 9, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 of a ML-based system 102 for uncertainty-aware traversability estimation (i.e., uncertainty object estimation) with optimum-fidelity scan data, in accordance with an embodiment of the present disclosure.

According to an exemplary embodiment of the present disclosure, FIG. 1 depicts the network architecture 100 may include the ML-based system 102, a database 104, one or more scanner devices 106, and one or more robotic devices 116. The ML-based system 102 may be communicatively coupled to the database 104, the one or more scanner devices 106, and the one or more robotic devices 116 via a communication network 108. The communication network 108 may be a wired communication network and/or a wireless communication network. The database 104 may include, but is not limited to, storing, and managing data related to traversability data, synthetic data, one or more robotic device information, scanner device information, and the like.

The database 104 may be any kind of database including, but are not limited to, relational databases, non-relational databases, graph databases, document databases, dedicated databases, dynamic databases, monetized databases, scalable databases, cloud databases, distributed databases, any other databases, and a combination thereof. The database 104 is configured to support the functionality of the ML-based system 102 and enables efficient data retrieval and storage for various aspects associated with the traversability estimation.

In an exemplary embodiment, the one or more scanner devices 106 are responsible for capturing high-precision scan data of one or more environments, contributing to the creation of an accurate point cloud for traversability analysis. The one or more scanner devices 106 may include, but not limited to, at least one of: laser scanners, lidar devices, structured light scanners, Time-of-Flight (ToF) cameras, stereo cameras, photogrammetry systems, digital cameras, and the like. The one or more robotic devices 116 are configured to leverage the traversability estimation system to navigate through challenging terrains. The one or more robotic devices 116 may include, but not limited to, at least one of: legged robots, autonomous wheeled robots, autonomous tracked robots, semi-autonomous wheeled robots, semi-autonomous tracked robots, Unmanned Aerial Vehicles (UAVs), Unmanned Ground Vehicles (UGVs), autonomous vehicles, hybrid mobility robotic devices, and the like.

This integrated network architecture 100 facilitates seamless communication and data exchange, enabling the ML-based system 102 to operate cohesively for uncertainty-aware traversability estimation using the optimum-fidelity scan data. The ML-based system 102 is adapted to dynamic environments and enhance autonomous navigation that is underpinned by the effective collaboration among the ML-based system 102, the database 104, the one or more scanner devices 106, and the one or more robotic devices 116 within the communication network 108.

The ML-based system 102 is initially configured to obtain the optimum-fidelity scan data in a form of point cloud from the one or more scanner devices 106. In an embodiment, the optimum-fidelity scan data generated by the one or more scanner devices 106 comprise at least one of: one or more three-dimensional point clouds, information associated with optimum-resolution surfaces, depth and distance measurements, color and intensity attributes, spatial coordinates, associated with the one or more environments. The ML-based system 102 is further configured to generate an elevation map of the one or more environments by applying at least one of: an elevation mapping model and free-space detection model on the point cloud.

The ML-based system 102 is further configured to generate a dense point cloud with one or more ground-truth map features from the elevation map of the one or more environments. The ML-based system 102 is further configured to generate a synthetic point cloud based on the dense point cloud of the one or more environments. The ML-based system 102 is further configured to predict one or more traversability features from the synthetic point cloud associated with the one or more environments using a machine learning (ML) model. The ML-based system 102 is further configured to determine the traversability with the uncertainty object estimation, which adapts the one or more robot devices to navigate on the one or more terrains, based on the one or more traversability features predicted from the ML model.

Further, the ML-based system 102 may be implemented by way of a single device or a combination of multiple devices that may be operatively connected or networked together. The ML-based system 102 may be implemented in hardware or a suitable combination of hardware and software. The ML-based system 102 includes one or more hardware processors 110, and a memory unit 112. The memory unit 112 may include a plurality of subsystems 114. The ML-based system 102 may be a hardware device including the one or more hardware processors 110 executing machine-readable program instructions for uncertainty-aware traversability estimation with optimum-fidelity scan data. Execution of the machine-readable program instructions by the one or more hardware processors 110 may enable the ML-based system 102 to dynamically recommend course of action sequence for uncertainty-aware traversability estimation with the optimum-fidelity scan data. The course of action sequences may involve various steps or decisions taken for data processing, traversability analysis, recommendation generation, action sequencing, and real-time adaptation of data. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the ML-based system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. A person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the ML-based system 102 as is unique to the present disclosure or necessary for an understanding of the present disclosure is depicted and described. The remainder of the construction and operation of the ML-based system 102 may conform to any of the various current implementations and practices that were known in the art.

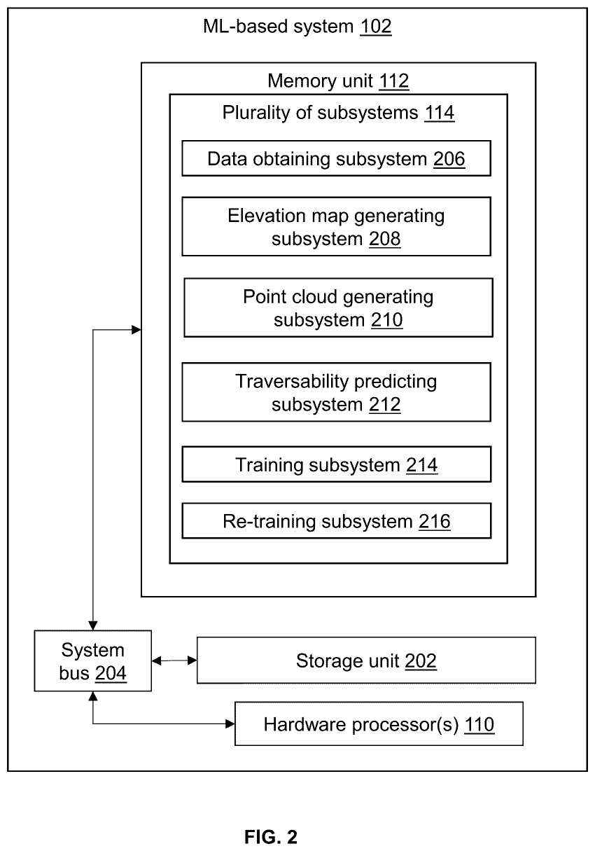

FIG. 2 illustrates an exemplary block diagram representation of the ML-based system as shown in FIG. 1 for the uncertainty-aware traversability estimation with the optimum-fidelity scan data, in accordance with an embodiment of the present disclosure.

The ML-based system 102 comprises the one or more hardware processors 110, the memory unit 112, and a storage unit 202. The one or more hardware processors 110, the memory unit 112, and the storage unit 202 are communicatively coupled through a system bus 204 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a data obtaining subsystem 206, an elevation map generating subsystem 208, a point cloud generating subsystem 210, a traversability predicting subsystem 212, a training subsystem 214, and a re-training subsystem 216.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be a non-transitory volatile memory and a non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 202 may be a cloud storage or the database 104 such as those shown in FIG. 1. The storage unit 202 may store, but is not limited to, recommending a course of action sequences, applications, application links, application name, application description, application meta-data, application identifier, display names of the one or more applications, short textual description, a universal resource locator (URL) of the one or more applications, and a list of parameters corresponding to an application context, generated recommending course of action sequences, one or more clickable elements, completion status of initiated user action through recommended course of action sequences, feedback loops, feedback from users, query parameters, additional query parameters, deep integration parameters, up-sell/x-sell product links, tracked user click-through rates, any other data, and combinations thereof. The storage unit 202 may be any kind of database such as, but are not limited to, relational databases, dedicated databases, dynamic databases, monetized databases, scalable databases, cloud databases, distributed databases, any other databases, and a combination thereof.

In an exemplary embodiment, the plurality of subsystems 114 includes the data obtaining subsystem 206 that is communicatively connected to the one or more hardware processors 110. The data obtaining subsystem 206 is configured to obtain the optimum-fidelity scan data from the one or more scanner devices 106. The one or more scanner devices 106 are configured to generate the optimum-fidelity scan data that include, but not limited to, detailed and accurate three-dimensional point clouds, optimum-resolution surface details, depth and distance measurements, color or intensity attributes, spatial coordinates, and the like. In a particular embodiment, the optimum-fidelity scan data is captured by the one or more scanner devices 106 including at least one of: FARO® Focus, Leica® BLK360, and the like. A precision and accuracy of the one or more scanner devices 106 is reaching up to 1 million points per scan with 1.0 mm precision. This precision exceeds that of low-resolution sensors such as lidars and cameras employed in the one or more robotic devices 116. The one or more scanner devices 106 are configured to generate an optimum-quality point cloud from six locations across four unique environments. The phrase “six locations” refers to six distinct positions or points in the real-time environment where the one or more scanner devices 106 is positioned to capture the optimum-quality point cloud.

The plurality of subsystems 114 includes the elevation map generating subsystem 208 that is communicatively connected to the one or more hardware processors 110. In order to enhance the accuracy of the optimum-fidelity scan data, the elevation map generating subsystem 208 is configured to employ an elevation mapping model and a free-space detection model on the point cloud to generate a detailed and accurate elevation map of the one or more environments. In an embodiment, the elevation map generating subsystem 208 is configured to allow one or more users to manually refine to determine free space in the elevation map to improve accuracy. If necessary, an additional sophisticated model may be applied to replace or enhance a refinement process. Further, one or more traversability features, including step, slope, and roughness, are extracted from local neighborhoods of elevation cells. This extract of traversability features involves analyzing the elevation map to identify nuanced terrain features for traversability analysis.

The plurality of subsystems 114 includes the point cloud generating subsystem 210 that is communicatively connected to the one or more hardware processors 110. The point cloud generating subsystem 210 is configured to generate a dense point cloud with one or more ground-truth map features from the elevation map of the one or more environments. In other words, the result of this local mapping step is a dense point cloud (P_{gt}) and corresponding map features (M_{gt}). This optimum-quality data is leveraged for training the ML model, ensuring a robust foundation for uncertainty-aware traversability estimation. The generated dense point cloud (P_{gt}) and map features (M_{gt}) are leveraged for training a neural network in the traversability estimation.

In an exemplary embodiment, the point cloud generating subsystem 210 is further configured to generate synthetic data including a synthetic point cloud based on the dense point cloud (P_{gt}) of the one or more environments for enhancing training capabilities of the ML-based system 102 to simulate real-world scenarios. The point cloud generating subsystem 210 is configured to generate training pairs (P, M) from the generated dense point cloud (P_{gt}) and map features (M_{gt}) to train the ML model (e.g., a neural network model).

The plurality of subsystems 114 includes the training subsystem 214 that is communicatively connected to the one or more hardware processors 110. The training subsystem 214 is configured to train the ML model. For training the ML model, the training subsystem 214 is initially configured to obtain one or more training datasets from the generated dense point cloud with the one or more ground-truth map features. The training subsystem 214 is further configured to train the ML model with the one or more training datasets obtained from the generated dense point cloud with the one or more ground-truth map features. The training subsystem 214 is further configured to predict the one or more traversability features using the trained ML model.

For generating the synthetic point cloud, a pose in freespace (p) is sampled/collected by the point cloud generating subsystem 210. This pose represents a virtual viewpoint in the environment that is not directly experienced by the one or more robotic devices 116. The dense point cloud (P_{gt}) is projected into a frame defined by the sampled pose (p). This process simulates what the low-resolution sensor is observed from a chosen viewpoint. The corresponding map features (M_{gt}) is transformed and cropped based on the sampled pose (p). A noising pipeline is applied to a synthetic point cloud (P) associated with the generated training pairs (P, M) to make the synthetic point cloud (P) resemble the output of the low-resolution sensors associated with the one or more robotic devices 116.

The plurality of subsystems 114 includes the traversability predicting subsystem 212 that is communicatively connected to the one or more hardware processors 110. The traversability predicting subsystem 212 is configured to predict/forecast the one or more traversability features directly from the synthetic point cloud (P) by the ML model. In an embodiment, the ML model may be an uncertainty navigation real-world network (UNRealNet). The UNRealNet is a PointPillars-based network design. The UNRealNet is supervised by minimizing the negative log-likelihood of a ground-truth map crop under a predicted map distribution. A mask (M_{gt}) (Equation 2) is used to mask unobserved cells in the ground truth map crop during training. The UNRealNet receives a training signal for cells observed in a label but not observed in an input, requiring the UNRealNet to inpaint map features. This assists the UNRealNet to handle cases where certain map features are not directly observed but need to be forecasted. The UNRealNet employs PointNet, cell-wise max-pooling, and a UNet which produces a cell-wise, factorized Gaussian distribution for several traversability features as depicted in Equation 1:

$$\begin{matrix}{f}_{θ} ( P ) = N ( \tilde{μ} , \tilde{σ} ) , & \tilde{μ} ∈ {R}^{C \times W \times H} , & \tilde{σ} ∈ {R}^{C \times W \times H}\end{matrix} \qquad Equation 1$$

$$L ( \hat{M} , {f}_{θ} ( P ) ) = \frac{{M}_{gt}}{\sum {M}_{gt}} {\sum }_{i = 0}^{W} {\sum }_{j = 0}^{H} {\sum }_{f = 0}^{C} [ - log log ( p ( {\hat{M}}^{f , i , j} , N ( {\tilde{μ}}^{f , i , j} , {\tilde{σ}}^{f , i , j} ) ) ) ] \qquad Equation 2$$

In an exemplary embodiment, the traversability predicting subsystem 212 is configured to estimate dense maps of the one or more traversability features. Unlike approaches that compute a single traversability function at train-time, the ML model (i.e., the UNRealNet) allows for dynamic traversability estimation at deployment time. This flexibility is crucial for adapting to different robot platforms associated with the one or more robotic devices 116, tuning the cost function, or addressing specific user needs without requiring re-training. The traversability predicting subsystem 212 is configured to consider traversability as the probability that all map features are below their critical values, given uncertainty estimates. The traversability is formulated mathematically as the probability that each map feature is below its critical value (Equation 3). The traversability predicting subsystem 212 is configured to assume each map feature is an independent Gaussian (i.e. f_{i,j}=(μ_{i,j}, σ_{i,j})), the formulation is simplified to require the evaluation and multiplication of several Gaussian cumulative distribution functions (cdfs) as formulated in Equation 4. This simplification is computationally efficient, suitable for real-time traversability estimation over large maps. The formulation simplifies the cost function by eliminating the need for the a parameter. This simplification reduces the burden on a robot operator during deployment.

$$p ( {T}^{i , j} ) = p ( {T}^{i , j} < {f}_{crit} , ∀ f ) \qquad Equation 3$$

$$p ( {T}^{i , j} ) = {\prod }_{f} cdf ( N ( {μ}^{f , i , j} , {σ}^{f , i , j} ) , {f}_{crit} ) \qquad Equation 4$$

The plurality of subsystems 114 includes the re-training subsystem 216 that is communicatively connected to the one or more hardware processors 110. The re-training subsystem 216 is configured to re-train the ML model for the one or more robot devices 116 based on at least one of: static traversability estimation at an execution time, changing of cost function, and one or more user requirements.

In an exemplary embodiment, experimental results and analysis are disclosed. In total, the ML-based system 102 is inputted with the optimum-fidelity scan data of five environments at three active construction sites. Each scan consists of a single floor (two floors are collected at two sites). The ML-based system 102 run the data generation process on each environment, yielding a total of around 30,000 train samples and 12,000 test samples (roughly a 70-30 test-train split). Additionally, a sixth environment (at a different site) is collected and used solely for testing. This site yields an additional 7,000 test samples. The ML model (i.e., the UNRealNet) is trained to predict 7 m×7 m local maps at a resolution of 5 cm, though maps of arbitrary size is predicted using this pipeline. The one or more traversability features may include at least one of a: terrain, elevation, step, local slope, local rough, slope, and rough. The terrain feature is characterized by the 1st percentile of heights within a cell, providing insights into the lowest elevations. The elevation, on the other hand, captures the 99th percentile of heights within a cell after the exclusion of points exceeding a predefined height threshold. The step feature quantifies the disparity between elevation and terrain, highlighting changes in the landscape. The local slope is computed by assessing the slope within a radius corresponding to a foothold size, contributing to a nuanced understanding of the immediate terrain.

Similarly, the local rough measures the height variance within a foothold-sized radius, providing information about the terrain's irregularities. The slope feature extends the analysis to the one or more robotic devices 116 footprint-sized radius, offering insights into the broader topographical features. Finally, roughness assesses the height variance within the one or more robotic devices 116 footprint radius, encompassing a larger area to capture more extensive terrain characteristics. The slope, step, and roughness are computed in the same way as disclosed in P. Fankhauser, M. Bjelonic, C. D. Bellicoso et al., “Robust roughterrain locomotion with a quadrupedal robot,” in 2018 IEEE International Conference on Robotics and Automation (ICRA). IEEE, 2018, pp. 5761-5768. In total, this results in a 7×140×140 tensor of labels per data point.

In an exemplary embodiment, the evaluation of UNRealNet's performance involves the ML-based system 102 ability to outperform standard baselines and examining the effectiveness of the probabilistic traversability function in capturing ground-truth traversability. Here are the detailed results and observations 1. Does UNRealNet Outperform Standard Baselines? The ML model (UNRealNet) is evaluated against several baseline methods, each serving a distinct purpose: baseline local mapping method, ablations and inpainting methods, and oracle baseline. The baseline local mapping method is the mapping algorithm used to generate features from aggregated laser scans, considering the simulated point cloud as input. The ablations and inpainting methods are compared, including those without point cloud augmentation (no aug), Telea's method (Telea), and Navier-Stokes-based inpainting (NS). The oracle baseline is equivalent to the baseline but with the placeholder determined by computing the Root Mean Square Error (RMSE)-minimizing value for each channel using ground-truth. The evaluation metrics include average RMSE for cells with ground-truth values (both), average RMSE for observed cells in the input point cloud (observed), and average RMSE for cells not observed in the point cloud but have ground-truth values (inpaint). Results for synthetic scans on a held-out region of each environment are reported in Table 1.

TABLE 1

| Em | Method | RMSE (observed) | RMSE (inpaint) | RMSE (both) |
|---|---|---|---|---|
| env1 | net (ours) | 0.1562 ± 0.0001 | 0.1987 ± 0.0009 | 0.1849 ± 0.0008 |
| | no aug | 0.2117 ± 0.0101 | 0.2618 ± 0.0121 | 0.2453 ± 0.0113 |
| | oracle | 0.2817 ± 0.0003 | 0.2736 ± 0.0003 | 0.2779 ± 0.0003 |
| | [symbol] | 0.2817 ± 0.0003 | 2.0402 ± 0.0017 | 1.6424 ± 0.0029 |
| | ns | 0.2817 ± 0.0003 | 0.3502 ± 0.0003 | 0.3298 ± 0.0003 |
| | baseline | 0.2817 ± 0.0003 | 0.4097 ± 0.0007 | 0.3740 ± 0.0005 |
| env2 | net (ours) | 0.2718 ± 0.0030 | 0.3608 ± 0.0036 | 0.3284 ± 0.0035 |
| | no aug | 0.3313 ± 0.0141 | 0.4208 ± 0.0142 | 0.3877 ± 0.0137 |
| | oracle | 0.3731 ± 0.0016 | 0.4210 ± 0.0007 | 0.4080 ± 0.0011 |
| | [symbol] | 0.3731 ± 0.0016 | 2.0930 ± 0.0154 | 1.6450 ± 0.0153 |
| | ns | 0.3731 ± 0.0016 | 0.4638 ± 0.0015 | 0.4327 ± 0.0017 |
| | baseline | 0.3731 ± 0.0016 | 0.4659 ± 0.0007 | 0.4350 ± 0.0012 |
| env3 | net (ours) | 0.1705 ± 0.0021 | 0.2370 ± 0.0017 | 0.2172 ± 0.0017 |
| | no aug | 0.2319 ± 0.0127 | 0.2902 ± 0.0114 | 0.2724 ± 0.0111 |
| | oracle | 0.2669 ± 0.0005 | 0.2937 ± 0.0004 | 0.2883 ± 0.0004 |
| | [symbol] | 0.2669 ± 0.0005 | 2.3610 ± 0.0058 | 1.9318 ± 0.0064 |
| | ns | 0.2669 ± 0.0005 | 0.3769 ± 0.0003 | 0.3474 ± 0.0003 |
| | baseline | 0.2669 ± 0.0005 | 0.4370 ± 0.0002 | 0.3940 ± 0.0002 |
| env4 | net (ours) | 0.1413 ± 0.0008 | 0.2252 ± 0.0014 | 0.2071 ± 0.0012 |
| | no aug | 0.2033 ± 0.0099 | 0.2845 ± 0.0077 | 0.2663 ± 0.0078 |
| | oracle | 0.2629 ± 0.0001 | 0.2739 ± 0.0003 | 0.2728 ± 0.0002 |
| | [symbol] | 0.2629 ± 0.0001 | 2.8353 ± 0.0028 | 2.4492 ± 0.0017 |
| | ns | 0.2629 ± 0.0001 | 0.4132 ± 0.0005 | 0.3830 ± 0.0005 |
| | baseline | 0.2629 ± 0.0001 | 0.4165 ± 0.0009 | 0.3868 ± 0.0007 |
| env5 | net (ours) | 0.1748 ± 0.0016 | 0.2792 ± 0.0019 | 0.2483 ± 0.0018 |
| | no aug | 0.2313 ± 0.0104 | 0.3260 ± 0.0135 | 0.2969 ± 0.0114 |
| | oracle | 0.2439 ± 0.0005 | 0.3345 ± 0.0005 | 0.3084 ± 0.0002 |
| | [symbol] | 0.2439 ± 0.0005 | 2.4452 ± 0.0238 | 1.9733 ± 0.0227 |
| | ns | 0.2439 ± 0.0005 | 0.3635 ± 0.0008 | 0.3297 ± 0.0008 |
| | baseline | 0.2439 ± 0.0005 | 0.4263 ± 0.0005 | 0.3761 ± 0.0008 |
| env6 | net (ours) | 0.1920 ± 0.0012 | 0.2708 ± 0.0016 | 0.2537 ± 0.0015 |
| | no aug | 0.2466 ± 0.0087 | 0.3156 ± 0.0086 | 0.3001 ± 0.0079 |
| | oracle | 0.2985 ± 0.0004 | 0.2998 ± 0.0003 | 0.3023 ± 0.0003 |
| | [symbol] | 0.2985 ± 0.0004 | 2.8835 ± 0.0098 | 2.4849 ± 0.0099 |
| | ns | 0.2985 ± 0.0004 | 0.4364 ± 0.0005 | 0.4092 ± 0.0005 |
| | baseline | 0.2985 ± 0.0004 | 0.4598 ± 0.0008 | 0.4260 ± 0.0008 |
| env6 | net (ours) | 0.2200 ± 0.0014 | 0.2866 ± 0.0008 | 0.2587 ± 0.0007 |
| ouster | no aug | 0.2217 ± 0.0018 | 0.2744 ± 0.0014 | 0.2628 ± 0.0014 |
| | oracle | 0.3229 ± 0.0007 | 0.2941 ± 0.0000 | 0.3046 ± 0.0002 |
| | [symbol] | 0.3229 ± 0.0007 | 2.4206 ± 0.0213 | 2.1006 ± 0.0209 |
| | ns | 0.3229 ± 0.0007 | 0.4322 ± 0.0020 | 0.4118 ± 0.0017 |
| | baseline | 0.3229 ± 0.0007 | 0.4658 ± 0.0003 | 0.4374 ± 0.0004 |

[symbol]

indicates data missing or illegible when filed

The refining individual scans through an additional ICP (Iterative Closest Point) step due to drift in the SLAM solution is highlighted. This refinement process results in around 800 scans in total. This step is crucial for enhancing the accuracy of individual scans and aligning them properly, considering the inherent drift in the SLAM (Simultaneous Localization and Mapping) solution. The iterative refinement through ICP contributes to achieving a more accurate representation of the environment, ensuring that the collected data aligns closely with the ground truth and improving the overall quality of the dataset. The results may describe that the ML model (UNRealNet) outperforms all baselines across all metrics on various evaluation datasets, including a sixth environment (env6). Performance gains with UNRealNet are observed for both observed and unobserved cells, indicating its robustness to factors like occlusion and sparse sensing. Inpainting baselines perform poorly compared to the oracular baseline, likely due to the sparsity of input data and the need for both interpolation and extrapolation.

2. Does the Probabilistic Traversability Function Better Capture Ground-Truth? In this evaluation, the accuracy of the probabilistic traversability function is compared to ground-truth traversability, and results are contrasted with the method used by A. Chilian and H. Hirschmuller, “Stereo camera-based navigation of mobile robots on rough terrain,” in 2009 IEEE/RSJ International Conference on Intelligent Robots and Systems. IEEE, 2009, pp. 4571-4576. and P. Fankhauser, M. Bjelonic, C. D. Bellicoso et al., “Robust roughterrain locomotion with a quadrupedal robot,” in 2018 IEEE International Conference on Robotics and Automation (ICRA). IEEE, 2018, pp. 5761-5768. The evaluation of Mean Absolute Error (MAE) for the predicted traversability values compared to the ground truth map. The results are presented in Table 2 for the test set, and the evaluation involves a random sampling of traversability thresholds. The MAE serves as a metric to assess the accuracy of the predicted traversability values by quantifying the average absolute difference between the predicted values and the corresponding ground truth values. This analysis helps gauge the performance of the traversability prediction model in capturing the ground truth traversability under varying threshold conditions.

TABLE 2

| Method | MAE |
|---|---|
| Det. [16, 18] | 0.3000 ± 0.0546 |
| Prob. (ours) | 0.2326 ± 0.0694 |

The results may describe that the uncertainty-aware traversability function demonstrates closer alignment with ground-truth traversability compared to the deterministic method used by Chilian and Fankhauser. Incorporating uncertainty allows the traversability estimation to be less sensitive to mispredictions, particularly in areas with assigned high uncertainty.

Overall Observations state that the ML model (UNRealNet) exhibits superior performance across multiple evaluation metrics and datasets, showcasing its effectiveness in traversability estimation. The probabilistic traversability function, by considering uncertainty, enhances the model's resilience to mispredictions and provides a more accurate representation of ground-truth traversability. These findings collectively demonstrate the robustness and efficacy of the UNRealNet in traversability analysis, making it a promising solution for real-world applications in challenging environments.

In an exemplary embodiment, hardware experiments are conducted to demonstrate the effectiveness of the traversability analysis method in real-world scenarios, particularly on legged robotic platforms. 1. Robot-Agnosticism: Multiple traversability maps are generated from the same the UNRealNet prediction for a specific environment (env 6). The traversability function accounts for robot-specific mobility limitations, producing a corresponding cost. The ML model (UNRealNet) can detect and evaluate traversability of challenging terrain elements, such as a small pile of wires, adjusting cost based on traversability thresholds.

2. Kalman Filter: The traversability pipeline can fuse multiple predictions using a one-dimensional Kalman Filter. Uncertainty in neural network predictions (μ, σ per feature, per cell) is leveraged to run the Kalman Filter, improving estimation of terrain features. Traversability is computed from the Kalman-filtered estimates (\tilde{σ}, \tilde{σ}).

3. The speed of the method is compared to STEP, both run on an AMD Ryzen 9 5900hx CPU and NVIDIA 3060 Laptop GPU. Despite being slightly slower, the runtime is comparable to STEP (around 7 Hz compared to STEP's 13 Hz). Runtime is influenced by preprocessing the point cloud for the network and converting the network's output into a grid map. Suggested optimizations include re-implementing the Python inference node in C++ and leveraging tools like TensorRT. Suggested optimizations include re-implementing the Python inference node in C++ and leveraging tools like TensorRT.

In another exemplary embodiment, Equation 1, Equation 2, Equation 3, and Equation 4 serve as illustrative representations of several traversability features within the UNRealNet. It is understood by the person skilled in the art that these equations are presented for explanatory purposes and are not exhaustive. The skilled artisan will appreciate that variations, modifications, and alternative formulations of these equations, capturing the essence of the traversability features, fall within the contemplation of this disclosure. The embodiments disclosed herein are therefore not limited to the precise equations presented, but rather encompass a broader range of mathematical expressions and formulations that achieve similar functionality.

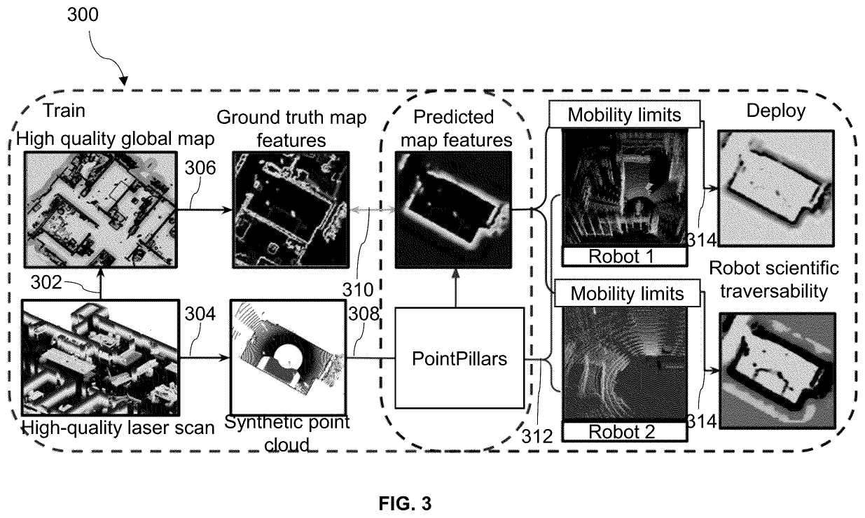

FIG. 3 illustrates an exemplary overview 300 of the ML-based system 102, in accordance with an embodiment of the present disclosure.

In an exemplary embodiment, the process begins with the generation of a high-quality elevation/global map (Step 302) derived from the point cloud obtained through a laser scanner. Subsequently, synthetic point clouds and their corresponding ground-truth map features are generated (Steps 304 and 306). The ML model (i.e., the UNRealNet) is then trained to predict high-quality, robot-agnostic map features from these noisy synthetic point clouds (Steps 308 and 310). The trained network can be deployed on the one or more robot devices 116 (Step 312), utilizing a robot-specific traversability function (Step 314). The ML model takes noisy synthetic point clouds as inputs and produces high-quality, robot-agnostic map features as outputs. The step 310 represents the training objective, as defined by the Equation 3. This comprehensive process forms an integrated pipeline for traversability estimation, enabling the deployment of the trained ML model on various robotic platforms with consideration for their specific traversability characteristics.

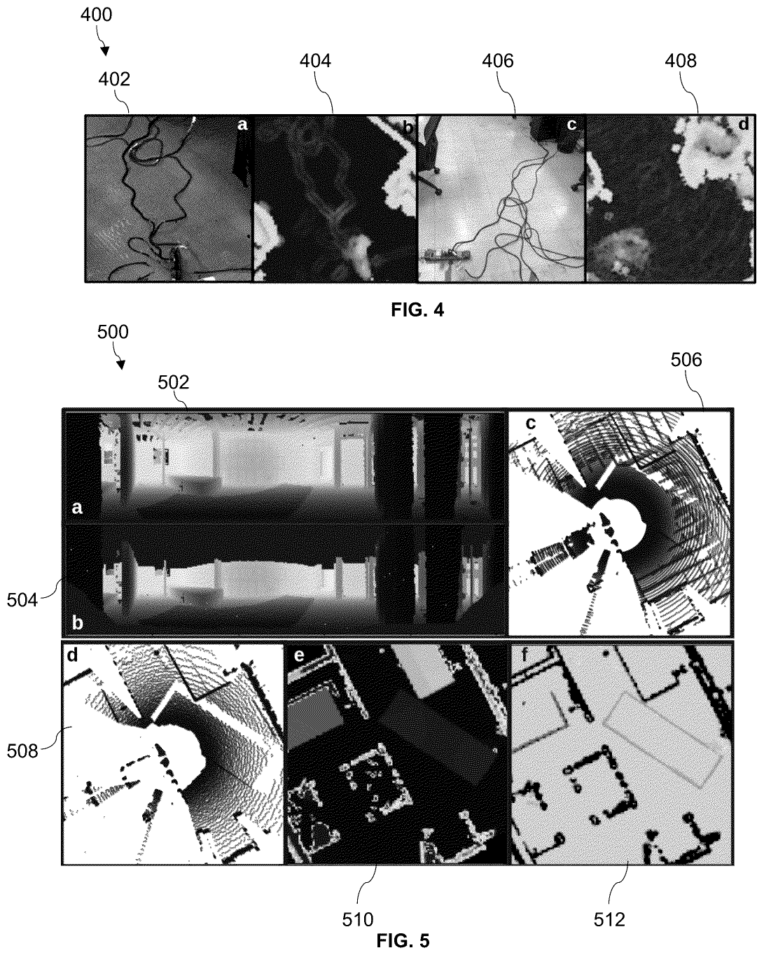

FIG. 4 illustrates an exemplary optimum-fidelity scan data of loose wires 400, in accordance with an embodiment of the present disclosure.

The significance of the optimum-fidelity scan data is exemplified in the following example. In optimum-fidelity scan 402 showcases the point cloud obtained from the high-resolution scanner. In optimum-fidelity scan 404, the slope feature of the corresponding local map is depicted, enabling the clear identification of the edges of each wire within the environment. In contrast, optimum-fidelity scan 406 displays a photo of the same environment, and optimum-fidelity scan 408 illustrates the slope feature derived from the registered point cloud obtained through lidar and SLAM. In this case, the noise from the lidar and SLAM is notably high, making it challenging to discern the wires clearly. This comparison underscores the enhanced capabilities of the high-resolution scanner in capturing detailed features with reduced noise, thereby contributing to more accurate traversability analysis.

FIG. 5 illustrates an exemplary visualization 500 of a datapoint associated with the ML-based system 102, in accordance with an embodiment of the present disclosure.

This visualization provides insight into a data point within our dataset. In visualization 502, the depth image is presented, simulated from lidar in the ground-truth point cloud, where blue indicates close proximity, and red signifies a greater distance. The visualization 504 showcases the depth image resulting from processing the original depth image through our established noising pipeline. The Bird's Eye View (BEV) projections of the original point cloud and the noised point cloud are depicted in the visualization 506 and 508 respectively. Additionally, the visualization 510 and 512 display corresponding excerpts from the ground-truth elevation map and a sample traversability map. This visualization captures the various stages of data processing, from simulated lidar readings to the generation of noised point clouds and the derived elevation and traversability features.

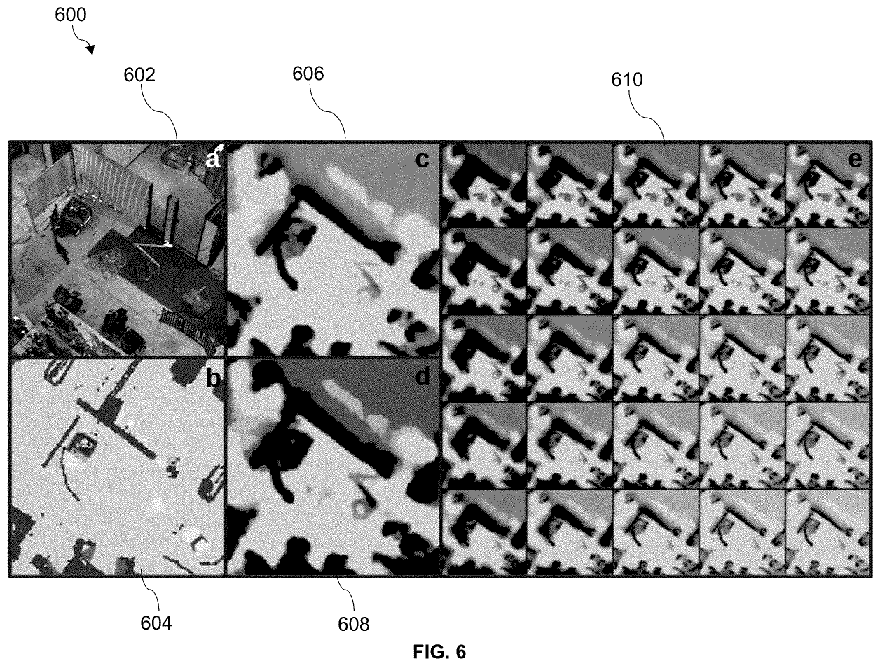

FIG. 6 illustrates an exemplary visualization of a traversability forecast with the ML model (UNRealNet) output on a sample in sixth environment (env6) 600, in accordance with an embodiment of the present disclosure.

This set of traversability predictions demonstrates the application of the same network output on a sample within env6. The visualization 602 offers a close-up view of the ground-truth point cloud, revealing a pile of wires at the center. The visualization 604 displays the corresponding ground-truth elevation map. The visualization 606 and 608 exhibit traversability maps generated using parameters for a Spot and AlienGo robot, respectively. Finally, the visualization 610 provides a mosaic of traversability maps, showcasing variations by adjusting the local slope (y-axis) and robot slope (x-axis) thresholds. This series illustrates the versatility of the traversability predictions across different robots and threshold configurations.

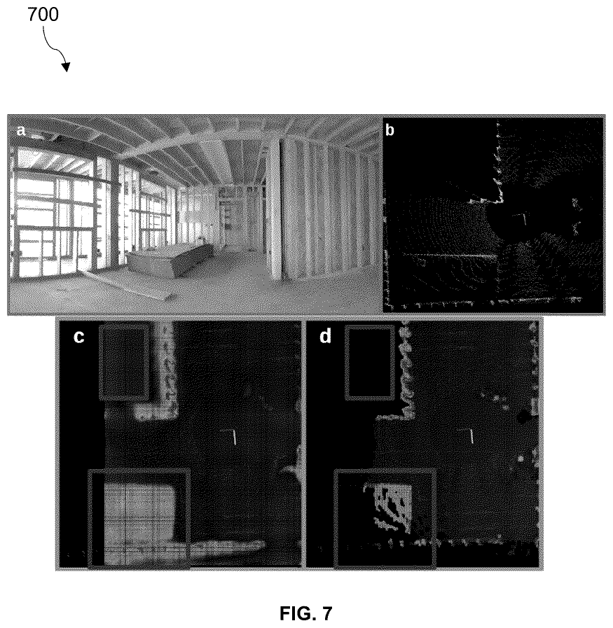

FIG. 7 illustrates an exemplary case study 700 for elevation forecast, in accordance with an embodiment of the present disclosure; and

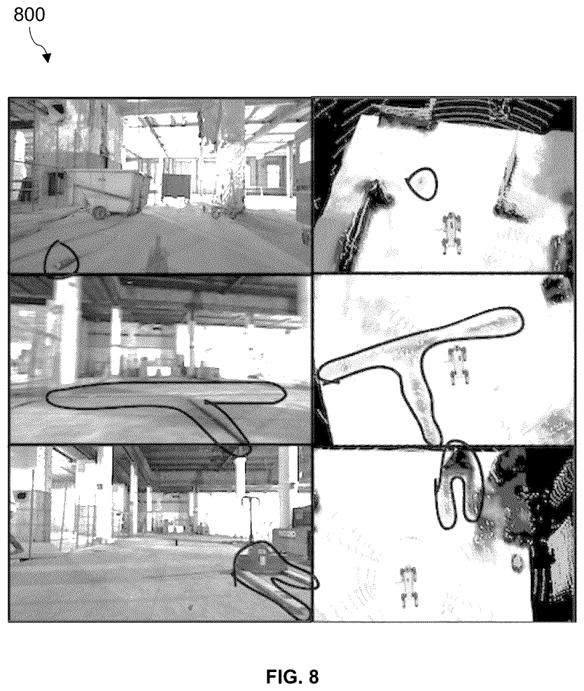

FIG. 8 illustrates exemplary additional qualitative results from a seventh environment 800, in accordance with an embodiment of the present disclosure.

The case study: A specific case study (FIG. 7) compares the learned elevation map by the UNRealNet to that produced by STEP. The UNRealNet demonstrates the ability to extrapolate using environmental priors, successfully inpainting features like crates, pillars, and floors. Correct prediction of hidden areas behind obstacles is observed. Additional qualitative results from a seventh environment (FIG. 8) showcase nuance in traversability estimation. Overall, the hardware experiments validate the versatility and practical applicability of the proposed traversability analysis method, showcasing its adaptability to various robotic platforms associated with the one or more robotic devices 116 and its capability to handle the complex real-world environments.

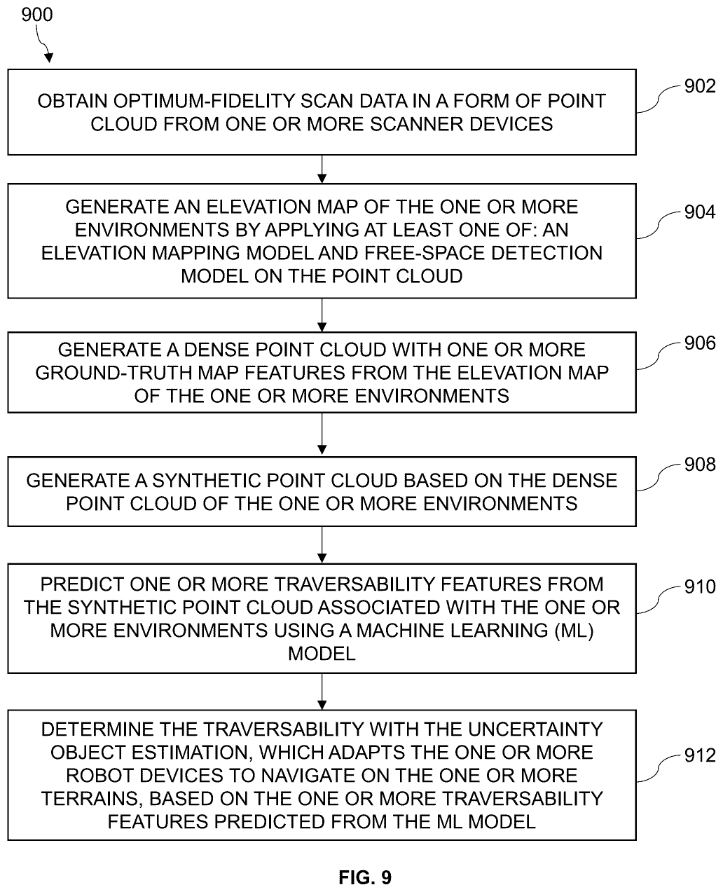

FIG. 9 illustrates a flow chart illustrating a machine learning based (ML-based) method 900 for the uncertainty-aware traversability estimation with the optimum-fidelity scan data, in accordance with an embodiment of the present disclosure.

At step 902, the optimum-fidelity scan data in a form of point cloud are obtained from one or more scanner devices 106. In an embodiment, the optimum-fidelity scan data generated by the one or more scanner devices 106 include at least one of: the one or more three-dimensional point clouds, the information associated with optimum-resolution surfaces, the depth and distance measurements, the color and intensity attributes, the spatial coordinates, associated with the one or more environments.

At step 904, the elevation map of the one or more environments is generated by applying at least one of: the elevation mapping model and the free-space detection model on the point cloud.

At step 906, the dense point cloud with the one or more ground-truth map features are generated from the elevation map of the one or more environments.

At step 908, the synthetic point cloud is generated based on the dense point cloud of the one or more environments.

At step 910, the one or more traversability features are predicted from the synthetic point cloud associated with the one or more environments using the machine learning (ML) model.

At step 912, the traversability with the uncertainty object estimation, which adapts the one or more robot devices 116 to navigate on the one or more terrains, is determined based on the one or more traversability features predicted from the ML model.

The present disclosure offers numerous advantages, as evident from the discussion above. The ML-based system 102 facilitates the use of cost-effective, low-resolution sensors on the one or more robotic devices 116 to navigate through challenging environments that would typically demand expensive, high-resolution sensors. This present invention not only reduces the computational load required for effective navigation but also minimizes the engineering effort associated with manual tuning and crafting of traversability analyses, a common requirement in prior art. Additionally, the ML-based system 102 introduced by this disclosure enables a comprehensive analysis of risk and probabilities in navigation and traversability, addressing a challenge often encountered in traditional methods where obtaining well-calibrated uncertainty estimates proves to be a complex task.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 102 either directly or through intervening I/O controllers. Network adapters may also be coupled to the ML-based system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 102 in accordance with the embodiments herein. The ML-based system 102 herein comprises at least one processor or central processing unit (CPU). The CPUs are interconnected via the system bus 204 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 102. The ML-based system 102 can read the inventive instructions on the program storage devices and follow these instructions to execute the methodology of the embodiments herein.

The ML-based system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A machine-learning based (ML-based) method for determining traversability with uncertainty object estimation for one or more robot devices to navigate through one or more terrains, the ML-based method comprising:
obtaining, by one or more hardware processors, optimum-fidelity scan data in a form of point cloud from one or more scanner devices, wherein the optimum-fidelity scan data generated by the one or more scanner devices comprise at least one of: one or more three-dimensional point clouds, information associated with optimum-resolution surfaces, depth and distance measurements, color and intensity attributes, spatial coordinates, associated with one or more environments;
generating, by the one or more hardware processors, an elevation map of the one or more environments by applying at least one of: an elevation mapping model and free-space detection model on the point cloud;
generating, by the one or more hardware processors, a dense point cloud with one or more ground-truth map features from the elevation map of the one or more environments;
generating, by the one or more hardware processors, a synthetic point cloud based on the dense point cloud of the one or more environments;
predicting, by the one or more hardware processors, one or more traversability features from the synthetic point cloud associated with the one or more environments using a machine learning (ML) model; and
determining, by the one or more hardware processors, the traversability with the uncertainty object estimation, which adapts the one or more robot devices to navigate on the one or more terrains, based on the one or more traversability features predicted from the ML model.

2. The ML-based method of claim 1, further comprising extracting, by the one or more hardware processors, the one or more traversability features comprising at least one of: step, slope, and roughness, of the one or more terrains, from one or more neighborhoods of one or more elevation cells, based on an analysis of the elevation map of the one or more environments.

3. The ML-based method of claim 1, further comprising training, by the one or more hardware processors, the ML model, by:
obtaining, by the one or more hardware processors, one or more training datasets from the generated dense point cloud with the one or more ground-truth map features;
training, by the one or more hardware processors, the ML model with the one or more training datasets obtained from the generated dense point cloud with the one or more ground-truth map features; and
predicting, by the one or more hardware processors, the one or more traversability features using the trained ML model.

4. The ML-based method of claim 1, wherein generating the synthetic point cloud based on the dense point cloud of the one or more environments, comprises:
collecting, by the one or more hardware processors, one or more poses indicating one or more virtual viewpoints, in one or more free spaces in the one or more environments;
projecting, by the one or more hardware processors, the generated dense point cloud into one or more frames defined by the collected one or more poses;
cropping, by the one or more hardware processors, the one or more ground-truth map features upon a transformation process on the one or more ground-truth map features, based on the collected one or more poses; and
applying, by the one or more hardware processors, noising data to the synthetic point cloud associated with the one or more training datasets to make the synthetic point cloud having outputs similar to outputs of one or more low-resolution sensors associated with the one or more robot devices.

5. The ML-based method of claim 1, wherein predicting the one or more traversability features from the synthetic point cloud associated with the one or more environments using the machine learning (ML) model, comprises:
defining, by the one or more hardware processors, one or more metric regions around an ego-pose comprising at least one of: a resolution, width and height, in the synthetic point cloud;
passing, by the one or more hardware processors, one or more points in the one or more metric regions through a point pillars network comprising at least one of: a point net and a cell-wise max-pooling; and
generating, by the one or more hardware processors, a cell-wise and factorized gaussian distribution for the one or more traversability features based on the point pillars network with the one or more points in the one or more metric regions, using the ML model.

6. The ML-based method of claim 1, further comprising at least one of:
analyzing, by the one or more hardware processors, the traversability as probability that the predicted one or more traversability features are below to critical threshold values; and
analyzing, by the one or more hardware processors, the traversability with the uncertainty object estimation when the predicted one or more traversability features are exceeded to the critical threshold values.

7. The ML-based method of claim 1, further comprising re-training, by the one or more hardware processors, the ML model for the one or more robot devices based on at least one of: static traversability estimation at an execution time, changing of cost function, and one or more user requirements.

8. A machine-learning based (ML-based) system for determining traversability with uncertainty object estimation for one or more robot devices to navigate through one or more terrains, the ML-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain optimum-fidelity scan data in a form of point cloud from one or more scanner devices, wherein the optimum-fidelity scan data generated by the one or more scanner devices comprise at least one of: one or more three-dimensional point clouds, information associated with optimum-resolution surfaces, depth and distance measurements, color and intensity attributes, spatial coordinates, associated with one or more environments;
an elevation map generating subsystem configured to generate an elevation map of the one or more environments by applying at least one of: an elevation mapping model and free-space detection model on the point cloud;
a point cloud generating subsystem configured to:
generate a dense point cloud with one or more ground-truth map features from the elevation map of the one or more environments; and
generate a synthetic point cloud based on the dense point cloud of the one or more environments; and
a traversability predicting subsystem configured to:
predict one or more traversability features from the synthetic point cloud associated with the one or more environments using a machine learning (ML) model; and
determine the traversability with the uncertainty object estimation, which adapts the one or more robot devices to navigate on the one or more terrains, based on the one or more traversability features predicted from the ML model.

9. The ML-based system of claim 8, wherein the traversability predicting subsystem is configured to extract the one or more traversability features comprising at least one of: step, slope, and roughness, of the one or more terrains, from one or more neighborhoods of one or more elevation cells, based on an analysis of the elevation map of the one or more environments.

10. The ML-based system of claim 8, further comprising a training subsystem configured to train the ML model, by:
obtaining one or more training datasets from the generated dense point cloud with the one or more ground-truth map features;
training the ML model with the one or more training datasets obtained from the generated dense point cloud with the one or more ground-truth map features; and
predicting the one or more traversability features using the trained ML model.

11. The ML-based system of claim 8, wherein in generating the synthetic point cloud based on the dense point cloud of the one or more environments, the point cloud generating subsystem is configured to:
collect one or more poses indicating one or more virtual viewpoints, in one or more free spaces in the one or more environments;
project the generated dense point cloud into one or more frames defined by the collected one or more poses;
crop the one or more ground-truth map features upon a transformation process on the one or more ground-truth map features, based on the collected one or more poses; and
apply noising data to the synthetic point cloud associated with the one or more training datasets to make the synthetic point cloud having outputs similar to outputs of one or more low-resolution sensors associated with the one or more robot devices.

12. The ML-based system of claim 8, wherein in predicting the one or more traversability features from the synthetic point cloud associated with the one or more environments using the machine learning (ML) model, the traversability predicting subsystem is configured to:
define one or more metric regions around an ego-pose comprising at least one of: a resolution, width and height, in the synthetic point cloud;
pass one or more points in the one or more metric regions through a point pillars network comprising at least one of: a point net and a cell-wise max-pooling; and
generate a cell-wise and factorized gaussian distribution for the one or more traversability features based on the point pillars network with the one or more points in the one or more metric regions, using the ML model.

13. The ML-based system of claim 8, wherein the traversability predicting subsystem is further configured to:
analyze the traversability as probability that the predicted one or more traversability features are below to critical threshold values; and
analyze the traversability with the uncertainty object estimation when the predicted one or more traversability features are exceeded to the critical threshold values.

14. The ML-based system of claim 8, further comprising a re-training subsystem configured to re-train the ML model for the one or more robot devices based on at least one of: static traversability estimation at an execution time, changing of cost function, and one or more user requirements.

15. A non-transitory computer-readable storage medium having instructions stored therein that when executed by one or more hardware processors, cause the one or more hardware processors to execute operations of:
obtaining optimum-fidelity scan data in a form of point cloud from one or more scanner devices, wherein the optimum-fidelity scan data generated by the one or more scanner devices comprise at least one of: one or more three-dimensional point clouds, information associated with optimum-resolution surfaces, depth and distance measurements, color and intensity attributes, spatial coordinates, associated with one or more environments;
generating an elevation map of the one or more environments by applying at least one of: an elevation mapping model and free-space detection model on the point cloud;
generating a dense point cloud with one or more ground-truth map features from the elevation map of the one or more environments;
generating a synthetic point cloud based on the dense point cloud of the one or more environments;
predicting one or more traversability features from the synthetic point cloud associated with the one or more environments using a machine learning (ML) model; and
determining the traversability with the uncertainty object estimation, which adapts the one or more robot devices to navigate on the one or more terrains, based on the one or more traversability features predicted from the ML model.

16. The non-transitory computer-readable storage medium of claim 15, further comprising training the ML model, by:
obtaining one or more training datasets from the generated dense point cloud with the one or more ground-truth map features;
training the ML model with the one or more training datasets obtained from the generated dense point cloud with the one or more ground-truth map features; and
predicting the one or more traversability features using the trained ML model.

17. The non-transitory computer-readable storage medium of claim 15, wherein generating the synthetic point cloud based on the dense point cloud of the one or more environments, comprises:
collecting one or more poses indicating one or more virtual viewpoints, in one or more free spaces in the one or more environments;
projecting the generated dense point cloud into one or more frames defined by the collected one or more poses;
cropping the one or more ground-truth map features upon a transformation process on the one or more ground-truth map features, based on the collected one or more poses; and
applying noising data to the synthetic point cloud associated with the one or more training datasets to make the synthetic point cloud having outputs similar to outputs of one or more low-resolution sensors associated with the one or more robot devices.

18. The non-transitory computer-readable storage medium of claim 15, wherein predicting the one or more traversability features from the synthetic point cloud associated with the one or more environments using the machine learning (ML) model, comprises:
defining one or more metric regions around an ego-pose comprising at least one of: a resolution, width and height, in the synthetic point cloud;
passing one or more points in the one or more metric regions through a point pillars network comprising at least one of: a point net and a cell-wise max-pooling; and
generating a cell-wise and factorized gaussian distribution for the one or more traversability features based on the point pillars network with the one or more points in the one or more metric regions, using the ML model.

19. The non-transitory computer-readable storage medium of claim 15, further comprising at least one of:
analyzing the traversability as probability that the predicted one or more traversability features are below to critical threshold values; and
analyzing the traversability with the uncertainty object estimation when the predicted one or more traversability features are exceeded to the critical threshold values.

20. The non-transitory computer-readable storage medium of claim 15, further comprising re-training the ML model for the one or more robot devices based on at least one of: static traversability estimation at an execution time, changing of cost function, and one or more user requirements.
